(19) United States
(12) Patent Application Publication
(10) Pub. No.: US 2009/0021649 A1
(43) Pub. Date: Jan. 22, 2009

(54) VIDEO APPARATUS AND METHOD FOR SUPPLYING POWER THEREOF

(75) Inventors: Chang-jin LEE, Suwon-si (KR); Tae-don HWANG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/968,344

(22) Filed: Jan. 2, 2008

(30) Foreign Application Priority Data
Jul. 16, 2007 (KR) 10-2007-0071356

(51) Int. Cl. H04N 5/63

(52) U.S. Cl. 348/730; 348/E05.127

(57) ABSTRACT

A video apparatus and a method for supplying power thereof are provided. The video apparatus includes a video processor which processes a video signal, a transceiver which receives a communication connection signal from an exterior apparatus, and a controller which allows power to be supplied to the video processor to generate the processed video signal to be output to the exterior apparatus through the transceiver, if the communication connection signal is received through the transceiver.

### CROSS-REFERENCE TO RELATED APPLICATIONS

This application claims priority under 35 U.S.C. § 119 from Korean Patent Application No. 10-2007-0071356, filed on Jul. 16, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a power supply, and more particularly, to a method for supplying power to reduce power consumption of a video apparatus in receiving a video signal and outputting a video corresponding the received video signal, and a video apparatus using the same.

2. Description of the Related Art

A video apparatus receives a video signal from an exterior via an antenna, and outputs a video corresponding to the video signal for a display. Generally, the video apparatus may be a set-top box, and the display may be a television (TV).

Generally, a video apparatus is paired with a display as a set by a wireless connection. The video apparatus attempts to connect with the display wirelessly, and outputs wirelessly a video to the display upon connecting.

A related art video apparatus supplies power to all the components even when a video is not output to a display apparatus. Power is supplied to all the components of the video apparatus irrespective of the state of wireless connection, even when the apparatus attempts a wireless connection with the display apparatus or awaits such connection.

Accordingly, in the related art video apparatus, power is supplied to the components for receiving a video signal, for processing the received signal, and for outputting a video to a display apparatus, although the video is currently not output to the display apparatus.

Because power is supplied to the components which are not used, power consumption is increased, and the life span of the components of the apparatus is shortened.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a method for supplying power to reduce power consumption of a video apparatus in outputting a video wirelessly to a display apparatus, and a video apparatus using the same.

The present invention also provides a video apparatus supplying power to components related to wireless communication when a display apparatus is in a standby state, and connected with the video apparatus wirelessly, and a method for supplying power thereof.

The present invention also provides a video apparatus supplying power to components related to a video processing to output a video to a display apparatus when the display apparatus is connected with the video apparatus wirelessly.

According to an exemplary aspect of the present invention, there is provided a video apparatus comprising a video processor which processes a video signal; a transceiver which receives a communication connection signal from an exterior apparatus; and a controller which controls to supply power to the video processor to generate the processed video signal to be output to the exterior apparatus through the transceiver, if the communication connection signal is received through the transceiver.

The apparatus may further comprise a tuner which receives the video signal, wherein if the communication connection signal is received through the transceiver, the controller controls to supply the power to the tuner.

The apparatus may further comprise a power supplier which supplies the power; a first switch which switches to supply the power to the tuner; a second switch which switches to supply the power to the video processor; and a third switch which switches to supply the power to the transceiver.

If the communication connection signal is not received through the transceiver, the controller may turn off the first and second switches not to supply the power to the tuner and the video processor.

The communication connection signal may be input wirelessly through the transceiver.

If the power is supplied, the controller may turn on the third switch to supply the power to the transceiver.

If the communication connection signal is received through the transceiver, the controller may turn on the first and second switches to supply the power to the tuner and the video processor.

According to an exemplary aspect of the present invention, there is provided a method for supplying power of a video apparatus, comprising determining whether a communication connection signal is input from an exterior apparatus; and if it is determined that the communication connection signal is input, supplying power to components related to a video processing to output a displayable video to the exterior apparatus.

If it is determined that the communication connection signal is not input, the power may not be supplied to the components related to the video processing.

The method may further comprise supplying the power to a communication component for communication with the exterior apparatus, if the power is supplied.

The communication connection signal may be input wirelessly through the communication component.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view illustrating a broadcast receiving system having a wireless set-top box according to an exemplary embodiment of the present invention; and

FIG. 2 is a flowchart illustrating a method for supplying power of a wireless set-top box according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

An exemplary embodiment of the present invention will be explained in detail with reference to drawings.

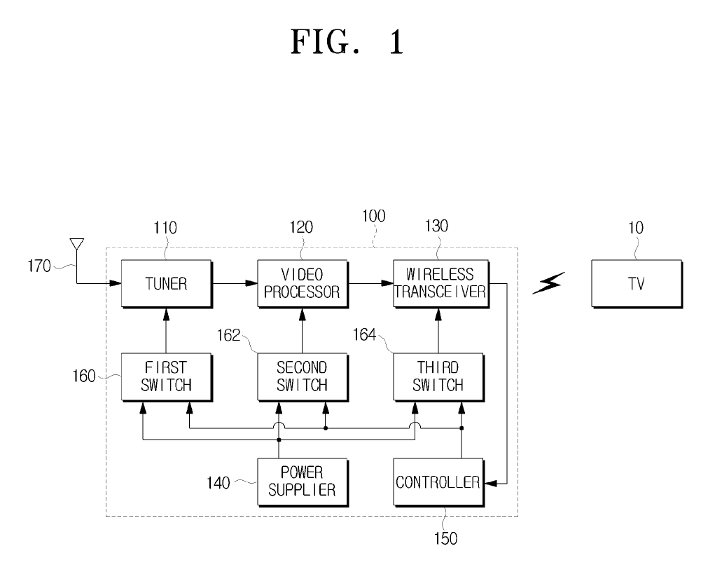

FIG. 1 is a view illustrating a broadcast receiving system having a wireless set-top box according to an exemplary embodiment of the present invention.

A wireless set-top box 100 supplies power to the components related to wireless communication with a television (TV) 10 when the TV 10 is in a standby state, and the wireless set-top box 100 is connected with the TV 10 for a wireless communication. The wireless set-top box 100 is an example of a video apparatus that provides power to a component related to a video processing and outputting to the TV 10 in a wireless connection.

Referring to FIG. 1, the wireless set-top box 100 is connected to the TV 10. The wireless set-top box 100 may comprise a tuner 110, a video processor 120, a wireless transceiver 130, a power supplier 140, a controller 150, and first to third switches 160, 162, and 164.

The tuner 110 receives a video signal via an antenna 170. The video processor 120 is a component to output a displayable video signal to the TV 10, and process the video signal received from the tuner 110 into the displayable video signal.

The wireless transceiver 130 is a component to wirelessly communicate with the TV 10. The wireless transceiver 130 converts the video signal processed by the video processor 120 into a video compliant with a wireless transmission standard, and outputs the converted video to the TV 10.

The power supplier 140 supplies power to the tuner 110, the video processor 120, the wireless transceiver 130, and the controller 150 which will be explained below.

The controller 150 controls a power supply to the tuner 110, the video processor 120, and the wireless transceiver 130. The controller 150 controls the switches 160, 162, and 164, not to supply the power to the tuner 110 and the video processor 120, but to supply the power to the wireless transceiver 130, when the TV 10 is turned off or is in a standby state.

The controller 150 supplies the power to the tuner 110 and the video processor 120 as well as the wireless transceiver 130 when the TV 10 is turned on, and a communication connection signal is received from the TV 10 through the wireless transceiver 130.

The first, second, and third switches 160, 162, and 164 are used to control the power supply. The first switch 160 is used to control the power supply to the tuner 110, the second switch 162 is used to control the power supply to the video processor 120, and the third switch 164 is used to control the power supply to the wireless transceiver 130.

When the TV 10 is in a standby state, the controller 150 turns off the first and second switches 160 and 162, and turns on the third switch 164. On the other hand, when the wireless set-top box 100 is connected with the TV 10 wirelessly, the controller 150 turns on the first to third switches 160, 162, and 164.

The second switch 162 is used only to control the power supply to the video processor 120, but it is merely an exemplary embodiment of the present invention. Because the voltage the video processor 120 uses for peaking, coring, sharpness, and noise removal is varied, a plurality of switches for controlling a voltage application for each function may be provided.

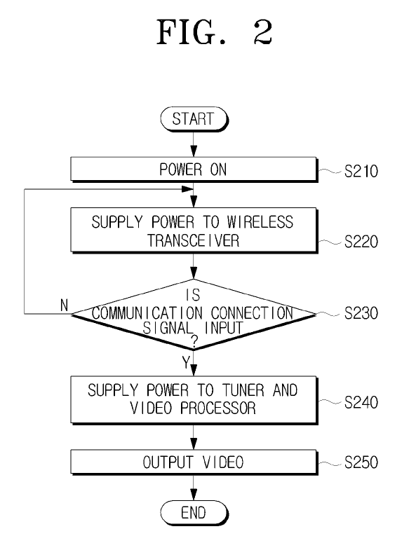

FIG. 2 is a flowchart illustrating a method for supplying power of a wireless set-top box according to an exemplary embodiment of the present invention.

Referring to FIG. 2, power is supplied to the wireless set-top box 100 according to a command of a user to turn on (S210).

If the power is supplied to the wireless set-top box 100, the controller 150 turns on the third switch 164 to supply power to the wireless transceiver 130 (S220), and turns off the first and second switches 160 and 162 so as to not supply power to the tuner 110 and the video processor 120. The wireless transceiver 130 continuously receives power supply to maintain a standby condition for a wireless connection.

The controller 150 determines whether a communication connection signal is input from the TV 10 (S230). If a user inputs a command to turn on using a remote controller, the TV 10 transmits the communication connection signal to the wireless set-top box 100. If the communication connection signal is input from the TV 10 through the wireless transceiver 130, the controller 150 determines that the power is supplied to the TV 10.

If the communication connection signal is input, the controller 150 turns on the first and second switches 160 and 162 to supply power to the tuner 110 and the video processor 120 (S240). For a time period that a video is not output to the TV 10, the TV 10 does not receive a video signal, nor does it have to process a signal of the received video. Accordingly, the controller turns off the first and second switches 160 and 162 not to supply the power to the tuner 110 and the video processor 120.

On the other hand, if a video is output to the TV 10, the tuner 110 has to receive the video signal, and the video processor 120 has to process the received video signal. Accordingly, the controller turns on the first and second switches 160 and 162 to supply the power to the tuner 110 and the video processor 120.

The wireless transceiver 130 outputs the video of the video signal processed by the video processor 120 to the TV 10 (S250).

If it is determined that the communication connection signal is not input, the controller 150 controls the first to third switches 160, 162, and 164, so that the power is supplied only to the wireless transceiver 130, excluding the tuner 110 and the video processor 120.

The power is supplied to the controller 150 and the wireless transceiver 130 while the video is not output to the TV 10 according to an exemplary embodiment of the present invention. As a result, power consumption of the video apparatus is reduced in comparison with a related art video apparatus which supplies the power to the entire components regardless of whether signal is received or not.

The first to third switches 160, 162, and 164 are provided to control power supply to the tuner 110, the video processor 120, and the wireless transceiver 130 in the above explanation, but it is merely an exemplary embodiment of the present invention. The controller 150 may control directly the power supplier 140 to control power supply to respective components in an alternative way.

The wireless set-top box 100 is provided as a video apparatus receiving a video signal, but it is merely an exemplary embodiment of the present invention. The present invention is also applicable to other alternative apparatuses which are connected with the TV 10 wirelessly and which output a video corresponding to a video signal received from the exterior to the TV 10. Any apparatus that has a component for receiving a video signal from the exterior, a component for processing a video, and a wireless communication component outputting a video to a display apparatus, may be applied.

While power is not supplied to the tuner 110 and the video processor 120 when the TV 10 is in a standby state in the above exemplary embodiment of the present invention, alternatively, the power may not be supplied to all the other components, except for a controller and components related to wireless communication.

The power consumption is reduced according to the present invention, as the power is not supplied to the components needless to an operation. Because redundant driving is prevented, a life span of the components of apparatus is expanded.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A video apparatus comprising:
a video processor which processes a video signal;
a transceiver which receives a communication connection signal from an exterior apparatus; and
a controller which causes power to be supplied to the video processor to generate the processed video signal to be output to the exterior apparatus through the transceiver, if the communication connection signal is received through the transceiver.

2. The apparatus of claim 1, further comprising:
a tuner which receives the video signal,
wherein if the communication connection signal is received through the transceiver, the controller causes power to be supplied to the tuner.

3. The apparatus of claim 2, further comprising:
a power supplier which supplies the power;
a first switch which switches to supply the power to the tuner;
a second switch which switches to supply the power to the video processor; and
a third switch which switches to supply the power to the transceiver.

4. The apparatus of claim 3, wherein if the communication connection signal is not received through the transceiver, the controller turns off the first and second switches so that the power is not supplied to the tuner and the video processor.

5. The apparatus of claim 1, wherein the communication connection signal is input wirelessly through the transceiver.

6. The apparatus of claim 3, wherein if the power is supplied, the controller turns on the third switch to supply the power to the transceiver.

7. The video apparatus of claim 3, wherein if the communication connection signal is received through the transceiver, the controller turns on the first and second switches to supply the power to the tuner and the video processor.

8. A method for supplying power of a video apparatus, comprising:
determining whether a communication connection signal is input from an exterior apparatus; and
if it is determined that the communication connection signal is input, supplying power to components related to a video processing to output a displayable video to the exterior apparatus.

9. The method of claim 8, wherein if it is determined that the communication connection signal is not input, the power is not supplied to the components related to the video processing.

10. The method of claim 8, further comprising:
if the power is supplied, supplying the power to a communication component for communication with the exterior apparatus.

11. The method of claim 8, wherein the communication connection signal is input wirelessly through the communication component.

12. The method of claim 8, wherein the supplying the power to components comprises turning on at least one switch.
